(19) United States
(12) Patent Application Publication
(10) Pub. No.: US 2007/0068615 A1
(43) Pub. Date: Mar. 29, 2007

(54) Method for manufacturing heat pipes

(75) Inventor: Shih-Che Chien, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/416,369

(22) Filed: May 1, 2006

(30) Foreign Application Priority Data
Sep. 23, 2005 (CN) 200510037494.1

(51) Int. Cl. B29C 65/06

(52) U.S. Cl. 156/73.5

(57) ABSTRACT

A method for manufacturing a heat pipe (10) according to one preferred embodiment includes following steps: providing a heat pipe preform (11) having an open end (13); filling working liquid (14) in the heat pipe preform; and sealing the open end of the heat pipe preform using a cover (12) by a friction welding process.

### BACKGROUND

1. Field of the Invention

The present invention relates to a method for manufacturing heat pipes.

2. DISCUSSION OF THE RELATED ART

Electronic components such as semiconductor chips are becoming progressively smaller, while at the same time heat dissipation requirements thereof are increasing. In many contemporary applications, a heat pipe is one of the most efficient systems in use for transmitting heat away from such components.

A typical heat pipe transports heat through an evaporation/condensation cycle. The heat pipe is made of a heat conductive material. In assembly, air is evacuated from the heat pipe, a working liquid such as water is filled in the heat pipe, and then the heat pipe is sealed. The heat pipe is essentially a receptacle (container) which transports heat as latent heat of the working liquid therein. Heat input from outside the heat pipe evaporates the working liquid, the vapor flows to a condenser section of the heat pipe having a low temperature and a low pressure, the vapor condenses, and the released heat radiates from the condenser section of the heat pipe. Because the heat is transmitted in the form of latent heat of the working liquid, the heat pipe has from more than ten times to several hundred times the heat transmitting capacity of that of copper, which is generally considered to have the highest heat conductivity among common metals.

The evaporated vapor phase working liquid flows to the condenser section due to the temperature and pressure differentials. After the heat is released, in a typical heat pipe, the condensed liquid phase working liquid is refluxed to the evaporator section by capillary action of a wick structure within the heat pipe.

A conventional method for manufacturing heat pipes includes the steps of providing a heat pipe preform with an open end and another closed end, filling working liquid into the heat pipe preform and sealing the open end of the heat pipe preform. The sealing step includes the following steps: pinching the open end of the heat pipe preform so as to form a flattened sealing portion, cutting a top end of the flattened sealing portion, and sealing the flattened sealing portion by a spot welding process.

However, the sealing step of the conventional method is very complex, which includes pinching, cutting and sealing. Furthermore, the flattened sealing portion increases the length of the heat pipe and is adverse to the capillary flow of the working liquid.

What is needed, therefore, is a method for manufacturing a heat pipe with a simple manufacturing process.

### SUMMARY

A method for manufacturing a heat pipe according to one preferred embodiment includes following steps: providing a heat pipe preform having an open end; filling working liquid into the heat pipe preform; and sealing the open end of the heat pipe preform using a cover by a friction welding process.

Compared with the conventional method for manufacturing a heat pipe, the present method for manufacturing heat pipes has the following advantages. The present method uses the cover to seal the open end of the heat pipe preform by the friction welding process, therefore, the method is simple due to the fact that it can be performed without pinching and cutting. Furthermore, the length of the pipe member need not increase. Thus the cost can be reduced and it does not influence the capillary flow of the working liquid so that the thermal properties of the heat pipe will be improved.

Other advantages and novel features will become more apparent from the following detailed description of present method for manufacturing heat pipes when taken in conjunction with the accompanying drawings.

### BRIEF DESCRIPTION OF THE DRAWINGS

Many aspects of the present method for manufacturing heat pipes can be better understood with reference to the following drawings. The components in the drawings are not necessarily drawn to scale, the emphasis instead being placed upon clearly illustrating the principles of the present method for manufacturing a heat pipe. Moreover, in the drawings, like reference numerals designate corresponding pales throughout the several views.

FIG. 1 is a flow chart of a method for manufacturing heat pipes in accordance with a preferred embodiment;

FIG. 2 is a schematic, side view of a heat pipe manufactured by the method of FIG. 1;

FIG. 3A is a schematic, side view of a cover of the heat pipe of FIG. 2;

FIG. 3B is a schematic, top view of a cover of the heat pipe of FIG. 2; and

FIG. 4 is a schematic view of sealing the heat pipe of FIG. 1.

### DETAILED DESCRIPTION OF PREFERRED EMBODIMENTS

Reference will now be made to the drawings to describe preferred embodiment of the present method for manufacturing a heat pipe, in detail.

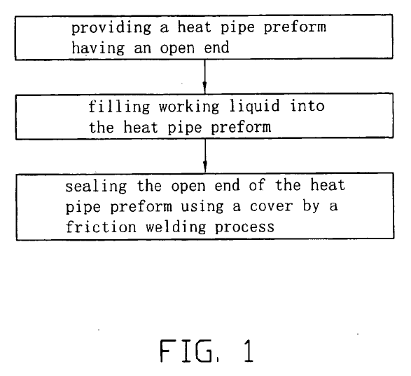

Referring to FIG. 1, a method for manufacturing a heat pipe in accordance with a preferred embodiment is shown. The method for manufacturing a heat pipe includes the following steps:

The first step is providing a heat pipe preform 11 having an open end 13.

The second step is filling working liquid 14 into the heat pipe preform 11.

The third step is sealing the open end 13 of the heat pipe preform 11 using a cover 12 by a friction welding process.

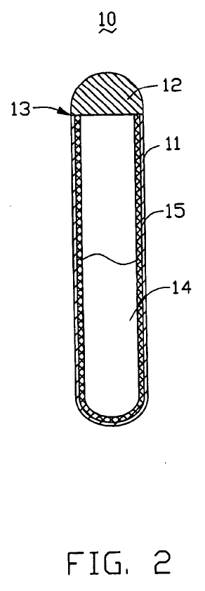

In the first step, the heat pipe preform 11 having an open end is provided. Referring to FIG. 2, the heat pipe preform 11 is hollow. The cross section of the heat pipe preform 11 has a shape selected from a group consisting of circular, ellipse, triangle, rectangle, square, and so on. That is, the open end 13 can be made shape above. A diameter of the heat pipe preform 11 is in a range from 2 millimeters to 200 millimeters. The heat pipe member 11 is made of a material selected from a group consisting of copper, aluminum, steel, carbon-steel, stainless-steel, iron, nickel, titanium and any appropriate combination alloy thereof. The heat pipe preform 11 also can be made of a polymer material, such as poly-aluminum silicate chloride or silicone rubber. In this embodiment, the heat pipe preform 11 is a circular copper tube, the diameter is 4 millimeters and the length is 50 millimeters.

The heat pipe preform 11 further includes a wick structure 15 for improving thermal conductivity.

In the second step, the working liquid 14 is filled into the heat pipe preform 11. Referring to FIG. 2, the working liquid 14 can be water, ammonia, carbinol, acetone, heptane, and so on. For enhancing thermal property of the working liquid 14, a plurality of thermally conductive particles, such as copper powder or carbon nanotubes can be added into the working liquid 14.

In the third step, the heat pipe preform 11 is sealed using the cover 12 by the friction welding process. The friction welding process is a solid welding method. It utilizes heat generated by friction as heat source to weld two pieces of metal or other such material together.

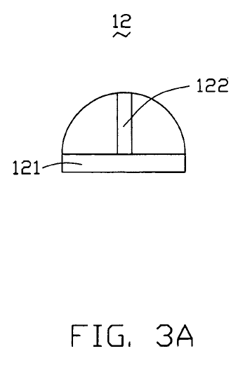

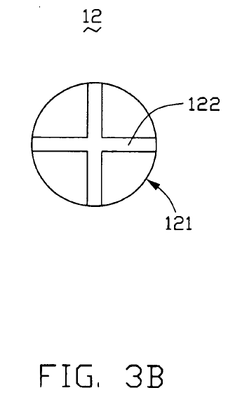

Referring to FIGS. 2 and 3, the cover 12 includes a joint portion 121 to seal the heat pipe preform 11. The joint portion 121 has a shape configured for mating with the shape of the open end 13 of the heat pipe preform 11. Therefore, the joint portion 121 of the cover 12 can be made circular, ellipsoid, triangular, rectangular, square, and so on. The cover 12 is also made of a material selected from the group consisting of copper, aluminum, steel, carbon-steel, stainless-steel, iron, nickel, titanium and a combination alloy thereof. The cover 12 can be also made of the polymer material, such as poly aluminum silicate chloride or silicone rubber. The joint portion 121 of the cover 12 is circular and has a diameter larger or equal to that of the heat pipe preform 11.

The cover 12 further includes an engaging head portion 122. The engaging head portion 122 is formed on the joint portion 121 of the cover 12 for fixing the cover 12 easily. The engaging heat portion 122 can has a shape of crisscross, linear, wave, ellipse, Y-shaped, triangle, etc.

In this embodiment, the joint portion 121 of the cover 12 is a circular copper cover, and the diameter is 4 millimeters so as to correspond to the heat pipe preform 11.

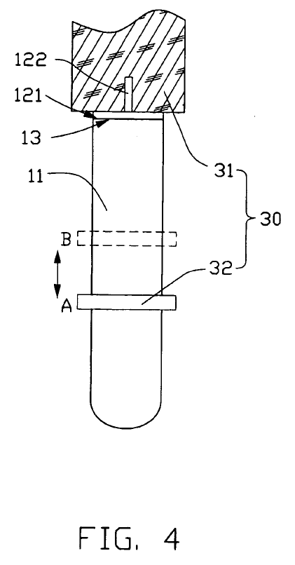

Referring to FIG. 4, the third step further includes the following steps:

The fourth step is aligning the cover 12 with the heat pipe preform 11, thereby the cover 12 and the heat pipe preform 11 share a common axis.

An apparatus 30 is provided for sealing the heat pipe 10. The apparatus 30 includes a first working table 31 configured for fixing and rotating the cover 12 and a second working table 32 configured for fixing the heat pipe preform 11. In the illustrated embodiment, the first working table 31 is immovable and rotates around a fixed position, and the second working table 32 is movable along the axis relative to the first working table 31. Alternatively, the second working table 32 could be immovable at a position, and the first working table 31 could be movable along and rotatable about the axis relative to the second working table 32.

The fifth step is bringing the cover 12 into contact with the open end 13 of the heat pipe preform 11.

The second working table 32 is moved form a position A to a position B to make the cover 12 into contact with the open end 13 of the heat pipe preform 11.

The sixth step is rotating the cover 12 about the axis so as to enable friction heat generated at an interface between the joint portion 121 of the cover 12 and the open end 13 of the heat pipe preform 11 to soften the joint portion 121 of the cover 12 and the open end 13 of the heat pipe preform 11.

The first working table is rotated so as to rotate the cover 12. Thus, a great deal of friction heat is generated at the interface between the joint portion 121 and the open end 13.

The seventh step is applying a compressive force to the joint portion 121, thereby obtaining the heat pipe 10 with the cover 12 hermetically attached to the open end 13 of the heat pipe preform 11.

The second working table 32 is controlled to push the heat pipe preform 11 against the joint portion 121 of the cover 12. With the friction heat generated at the interface between the joint portion 121 and the open end 13, the heat pipe 10 is manufactured with the cover 12 hermetically sealing the open end 13 of the heat pipe preform 11.

Alternatively, the sixth and seventh steps could be performed at the same time. Furthermore, if the second table 32 is immovable at a position and the first working table 31 may be movable along the axis and rotates, it only need to move and rotate the first working table to obtain the heat pipe 10 with the cover 12 sealingly attached to the open end 13 of the heat pipe preform 11.

Compared with conventional methods for manufacturing heat pipes, the present method for manufacturing heat pipes has following advantages. It uses a friction welding process to seal the heat pipe preform 11 with the cover 12, therefore, the present method is simplified by eliminating any pinching or cutting. Furthermore, the length of the heat pipe preform 11 will not be increased by the present method. Thus the cost is lowered and the capillary flow of the working liquid 14 is unrestricted so that the thermal properties are not unduly influenced

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A method for manufacturing a heat pipe, comprising the steps of:
providing a heat pipe preform having an open end;
filling a working liquid into the heat pipe preform; and
sealing the open end of the heat pipe preform using a cover by a friction welding process.

2. The method as claimed in claim 1, wherein sealing the friction welding process comprises the following steps:
aligning the cover with the heat pipe preform, the cover and the heat pipe preform thereby sharing a common axis;
bringing the cover into contact with the open end of the heat pipe preform;
rotating the cover about the axis so as to enable friction heat generated at an interface between the cover and the open end of the heat pipe preform to soften joint portions of the cover and the open end of the heat pipe preform; and
applying a compressive force to the joint portion, thereby obtaining the heat pipe with the cover being hermetically attached to the open end thereof.

3. The method as claimed in claim 1, wherein the joint portion of the cover is circular and has a diameter larger than that of the heat pipe preform.

4. The method as claimed in claim 1, wherein the joint portion of the cover is circular and has a diameter equal to that of the pipe member.

5. The method as claimed in claim 1, wherein a cross section of the heat pipe preform member has a shape selected from the group consisting of circular, ellipsoid, triangular, rectangular and square.

6. The method as claimed in claim 1, wherein a diameter of the heat pipe preform is in the range from 2 millimeters to 200 millimeters.

7. The method as claimed in claim 1, wherein the heat pipe preform is comprised of a material selected from a group consisting of copper, aluminum, steel, carbon-steel stainless-steel, iron, nickel, titanium and any appropriate combination alloy thereof.

8. The method as claimed in claim 1, wherein the heat pipe preform is comprised of a polymer material selected from a group consisting of poly-aluminum silicate chloride and silicone rubber.

9. The method as claimed in claim 1, wherein the joint portion of the cover has a shape configured for mating with the shape of the open end portion of the heat pipe preform.

10. The method as claimed in claim 9, wherein the cover has an engaging head portion.

11. The method as claimed in claim 10, wherein the engaging head portion has a shape selected from a group consisting of crisscross, linear, wave, ellipse, Y-shaped and triangle.

12. The method as claimed in claim 1, wherein the cover is comprised of a material selected from the group consisting of copper, aluminum, steel, carbon-steel, stainless-steel, iron, nickel, titanium and any appropriate combination alloy thereof.

13. The method as claimed in claim 1, wherein the cover is comprised of a polymer material selected from the group consisting of poly aluminum silicate chloride and silicone rubber.

14. The method as claimed in claim 1, wherein the working liquid is comprised of a material selected from the group consisting of water, ammonia, carbinol, acetone, and heptane.

15. The method as claimed in claim 14, wherein the working liquid further comprises a plurality of thermally conductive particles.

16. The method as claimed in claim 15, wherein the thermally conductive particles are comprised of copper powder or carbon nanotubes.
